(19) United States
(12) Patent Application Publication
(10) Pub. No.: US 2021/0047917 A1
(43) Pub. Date: Feb. 18, 2021

(54) Deep Structural Dip Determination And Improved Reflection Imaging Using Full-Waveform Borehole Sonic Data

(71) Applicant: Halliburton Energy Services, Inc.

(72) Inventors: Brian Edward Hornby, Fulshear, TX (US); George Christopher Tevis, Missouri City, TX (US)

(73) Assignee: Halliburton Energy Services, Inc., Houston, TX (US)

(21) Appl. No.: 16/603,646

(22) PCT Filed: Nov. 13, 2018
(86) PCT No.: PCT/US2018/060709

§ 371 Date: Oct. 8, 2019

(51) Int. Cl. E21B 47/12; G01V 1/44; E21B 47/002; G01V 1/30

(52) U.S. Cl. CPC E21B 47/12; G01V 1/303; E21B 47/0025; G01V 1/44

(57) ABSTRACT

The present disclosure relates to borehole sonic logging and, more particularly to, improved reflection imaging of formation structures away from the wellbore. A method for borehole sonic reflection imaging may comprise: disposing a borehole sonic logging tool in a wellbore, wherein the borehole sonic logging tool comprises one or more transmitters and one or more receivers; emitting sound waves from the one or more transmitters; receiving sound waves at the one or more receivers to obtain borehole sonic data; separating up-going arrivals in the borehole sonic data from down-going arrivals in the borehole sonic data; generating a first reflection image based at least on the borehole sonic data; estimating a relative dip angle of a formation bed from the first reflection image; generating an updated velocity model based at least on the relative dip angle; and generating an updated reflection image based at least on the updated velocity model.

### BACKGROUND

Wellbores drilled into subterranean formations may enable recovery of desirable fluids (e.g., hydrocarbons) using a number of different techniques. A logging tool may be employed in subterranean operations to determine wellbore and/or formation properties. Formation evaluation further from a wellbore is a critical step in reservoir characterization and monitoring. Logging tools typically measure the “near-field,” or in the proximity of the wellbore. Logging tools are evolving to measure the “far-field,” or large distances from the wellbore.

One formation parameter of interest may be the true dip angle of a formation. The term “true dip angle” refers to the steepest angle of descent of a tilted bed or other formation feature relative to a horizontal plane. True dip angle is the dip angle measured in a 2-dimensional (2D) plane oriented perpendicular to the formation's strike line (i.e., a line marking the intersection of the bed or feature with a horizontal plane). True dip angle may also be expressed as the angle between the vertical axis and a vector normal to the formation bedding plane. More generally, the true dip of a formation or other feature is simply characterized as the dip. The term “dip,” without any other qualifiers, will mean “true dip”. A related parameter is the relative dip angle, which is the angle between the wellbore axis and the vector normal to the formation bedding plane, measured in their common plane. It may be desirable to know the true dip angle both in the near-field and in the far-field. Currently, logging tools typically may be wellbore pad tools that generate images for dip analysis from current measurements. However, while these logging tools may be used to measure dip angle at the wellbore wall, they typically cannot provide dip angles at a given distance away from the wellbore. While other logging tools may be able to provide measurements at larger distances from the wellbore, they typically do not provide images suitable for dip analysis.

### BRIEF DESCRIPTION OF THE DRAWINGS

These drawings illustrate certain aspects of some examples of the present disclosure, and should not be used to limit or define the disclosure.

FIG. 1 illustrate an example of a borehole sonic logging system;

FIG. 2 illustrates an example of a drilling system;

FIG. 3 illustrate an example of a borehole sonic logging tool disposed in a wellbore;

FIG. 4 illustrate an example flowchart of a method for updating a velocity log;

FIG. 5 illustrate an example of a recorded sonic waveform;

FIG. 6A illustrate an example of raw recorded data;

FIG. 6B illustrate an example of filtered data;

FIG. 6C illustrate an example of filtered data at a specified depth;

FIG. 7 illustrate an example of representative log curves and a combined image of up-dip and down-dip formations;

FIG. 8 illustrate an example of a 2-D velocity model;

FIG. 9 illustrate an example of an image created with a 2-D velocity model;

FIG. 10 illustrate an example of a borehole sonic logging tool in a wellbore penetrating a dipping formation; and

FIG. 11 illustrate an example of a graph of the wave modes as a function of slowness.

### DETAILED DESCRIPTION

The present disclosure relates generally to borehole sonic logging and, more particularly to, improved reflection imaging of formation structures away from the wellbore. These images may be used by a geologist and/or geophysical interpreter for a number of things. For example, one may observe abrupt shifts in bedding features as might be caused by a fault plane, or in some cases, directly image the fault plane itself. Other uses may relate to changes in bedding dip away from the well, for example, as might be caused by an overturned fold structure. Those skilled in the art will realize that there may be many more potential geological structures that may be of interest to the skilled practitioner. By way of example, borehole sonic data may be gathered to construct a structure-guided velocity model to determine the relative dip angle of a formation bed from borehole sonic logging tools. In examples, the relative dip angle may be further manipulated to determine the true dip angle of the formation bed, with knowledge of the wellbore deviation and direction.

In contrast to prior logging tools, the present techniques may enable accurate determination of the dip angles in the near-field and the far-field. For example, the dip angles may be determined at distances of 5 feet (1.5 meters), 10 feet (3 meters), 20 feet (6 meters), 50 feet (15 meters), 100 feet (305 meters), or even further from the wellbore. The maximum distance imaged from the well may depend on a number of factors that will vary from case to case. Without limitation, these factors may include formation complexity, strength of sonic transmitter, sensitivity of sonic receivers, formation factors such as formation attenuation and velocity, and/or combinations thereof. With the relative dip angle of the bedding away from the wellbore, a more accurate velocity model may be obtained and used in generation of reflection images. The reflection images generated using the velocity model guided by the estimated relative dip angle may be more accurate.

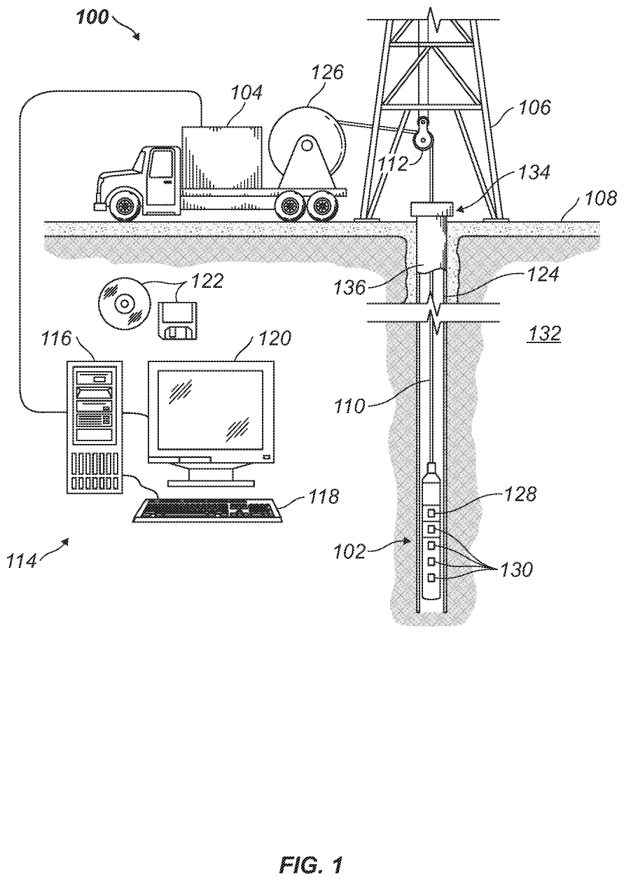

FIG. 1 illustrates a cross-sectional view of a borehole sonic logging system 100. As illustrated, borehole sonic logging system 100 may comprise a borehole sonic logging tool 102 attached to a vehicle 104. In examples, it should be noted that borehole sonic logging tool 102 may not be attached to a vehicle 104. Borehole sonic logging tool 102 may be supported by rig 106 at surface 108. Borehole sonic logging tool 102 may be tethered to vehicle 104 through conveyance 110. Conveyance 110 may be disposed around one or more sheave wheels 112 to vehicle 104. Conveyance 110 may include any suitable means for providing mechanical conveyance for borehole sonic logging tool 102, including, but not limited to, wireline, slickline, coiled tubing, pipe, drill pipe, downhole tractor, or the like. In some embodiments, conveyance 110 may provide mechanical suspension, as well as electrical connectivity, for borehole sonic logging tool 102. Conveyance 110 may comprise, in some instances, a plurality of electrical conductors extending from vehicle 104. Conveyance 110 may comprise an inner core of seven electrical conductors covered by an insulating wrap. An inner and outer steel armor sheath may be wrapped in a helix in opposite directions around the conductors. The electrical conductors may be used for communicating power and telemetry between vehicle 104 and borehole sonic logging tool 102. Information from borehole sonic logging tool 102 may be gathered and/or processed by information handling system 114. For example, signals recorded by borehole sonic logging tool 102 may be stored on memory and then processed by borehole sonic logging tool 102. The processing may be performed real-time during data acquisition or after recovery of borehole sonic logging tool 102. Processing may alternatively occur downhole or may occur both downhole and at surface. In some embodiments, signals recorded by borehole sonic logging tool 102 may be conducted to information handling system 114 by way of conveyance 110. Information handling system 114 may process the signals, and the information contained therein may be displayed for an operator to observe and stored for future processing and reference. Information handling system 114 may also contain an apparatus for supplying control signals and power to borehole sonic logging tool 102.

Systems and methods of the present disclosure may be implemented, at least in part, with information handling system 114. Information handling system 114 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system 114 may be a processing unit 116, a network storage device, or any other suitable device and may vary in size, shape, performance, functionality, and price. Information handling system 114 may include random access memory (RAM), one or more processing resources such as a central processing unit (CPU) or hardware or software control logic, ROM, and/or other types of nonvolatile memory. Additional components of the information handling system 114 may include one or more disk drives, one or more network ports for communication with external devices as well as various input and output (I/O) devices, such as a input device 118 (e.g., keyboard, mouse, etc.) and a video display 120. Information handling system 114 may also include one or more buses operable to transmit communications between the various hardware components.

Alternatively, systems and methods of the present disclosure may be implemented, at least in part, with non-transitory computer-readable media 122. Non-transitory computer-readable media 122 may include any instrumentality or aggregation of instrumentalities that may retain data and/or instructions for a period of time. Non-transitory computer-readable media 122 may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

As illustrated, borehole sonic logging tool 102 may be disposed in wellbore 124 by way of conveyance 110. Wellbore 124 may extend from a wellhead 134 into a formation 132 from surface 108. Generally, wellbore 124 may include horizontal, vertical, slanted, curved, and other types of wellbore geometries and orientations. Wellbore 124 may be cased or uncased. In examples, wellbore 124 may comprise a metallic material, such as tubular 136. By way of example, the tubular 136 may be a casing, liner, tubing, or other elongated steel tubular disposed in wellbore 124. As illustrated, wellbore 124 may extend through formation 132. Wellbore 124 may extend generally vertically into the formation 132. However, wellbore 124 may extend at an angle through formation 132, such as horizontal and slanted wellbores. For example, although wellbore 124 is illustrated as a vertical or low inclination angle well, high inclination angle or horizontal placement of the well and equipment may be possible. It should further be noted that while wellbore 124 is generally depicted as a land-based operation, those skilled in the art may recognize that the principles described herein are equally applicable to subsea operations that employ floating or sea-based platforms and rigs, without departing from the scope of the disclosure.

In examples, rig 106 includes a load cell (not shown) which may determine the amount of pull on conveyance 110 at surface 108 of wellbore 124. While not shown, a safety valve may control the hydraulic pressure that drives drum 126 on vehicle 104 which may reel up and/or release conveyance 110 which may move borehole sonic logging tool 102 up and/or down wellbore 124. The safety valve may be adjusted to a pressure such that drum 126 may only impart a small amount of tension to conveyance 110 over and above the tension necessary to retrieve conveyance 110 and/or borehole sonic logging tool 102 from wellbore 124. The safety valve is typically set a few hundred pounds above the amount of desired safe pull on conveyance 110 such that once that limit is exceeded; further pull on conveyance 110 may be prevented.

In examples, borehole sonic logging tool 102 may operate with additional equipment (not illustrated) on surface 108 and/or disposed in a separate borehole sonic logging system (not illustrated) to record measurements and/or values from formation 132. Borehole sonic logging tool 102 may comprise a transmitter 128. Transmitter 128 may be connected to information handling system 114, which may further control the operation of transmitter 128. Transmitter 128 may include any suitable transmitter for generating sound waves that travel into formation 132, including, but not limited to, piezoelectric transmitters. Transmitter 128 may be a monopole source or a multi-pole source (e.g., a dipole source). Combinations of different types of transmitters may also be used. During operations, transmitter 128 may broadcast sound waves from borehole sonic logging tool 102 that travel into formation 132. The sound waves may be emitted at any suitable frequency range. For example, a broad band response could be from about 0.2 KHz to about 20 KHz, and a narrow band response could be from about 1 KHz to about 6 KHz. It should be understood that the present technique should not be limited to these frequency ranges. Rather, the sounds waves may be emitted at any suitable frequency for a particular application.

Borehole sonic logging tool 102 may also include a receiver 130. As illustrated, there may be a plurality of receivers 130 disposed on borehole sonic logging tool 102. Receiver 130 may include any suitable receiver for receiving sound waves, including, but not limited to, piezoelectric receivers. For example, the receiver 130 may be a monopole receiver or multi-pole receiver (e.g., a dipole receiver). In examples, a monopole receiver 130 may be used to record compressional-wave (P-wave) signals, while the multi-pole receiver 130 may be used to record shear-wave (S-wave) signals. Receiver 130 may measure and/or record sound waves broadcast from transmitter 128 as received signals. The sound waves received at receiver 130 may include both direct waves that traveled along the wellbore 124 and refract through formation 132 as well as waves that traveled through formation 132 and reflect off of near-borehole bedding and propagate back to the borehole. The reflected waves may include, but are not limited to, compressional (P) waves and shear (S) waves. By way of example, the received signal may be recorded as an acoustic amplitude as a function of time. Information handling system 114 may control the operation of receiver 130. The measured sound waves may be transferred to information handling system 114 for further processing. In examples, there may be any suitable number of transmitters 128 and/or receivers 130, which may be controlled by information handling system 114. Information and/or measurements may be processed further by information handling system 114 to determine properties of wellbore 124, fluids, and/or formation 132. By way of example, the sound waves may be processed to generate a reflection image of formation structures, which may be used for dip analysis as discussed in more detail below.

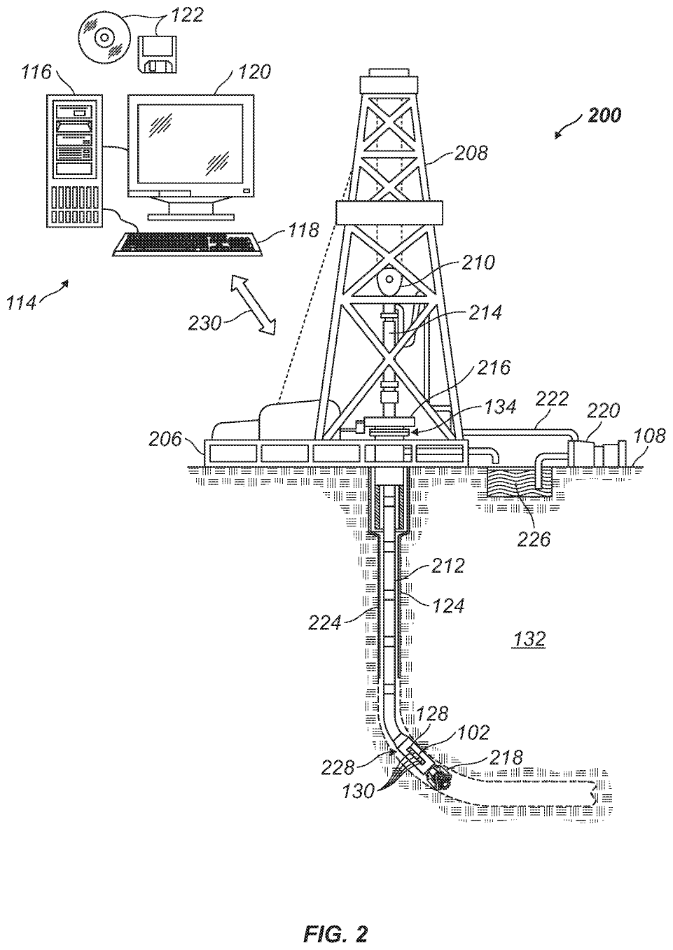

FIG. 2 illustrates an example in which borehole sonic logging tool 102 may be included in a drilling system 200. As illustrated, wellbore 124 may extend from wellhead 134 into formation 132 from surface 108. A drilling platform 206 may support a derrick 208 having a traveling block 210 for raising and lowering drill string 212. Drill string 212 may include, but is not limited to, drill pipe and coiled tubing, as generally known to those skilled in the art. A kelly 214 may support drill string 212 as it may be lowered through a rotary table 216. A drill bit 218 may be attached to the distal end of drill string 212 and may be driven either by a downhole motor and/or via rotation of drill string 212 from surface 108. Without limitation, drill bit 218 may include, roller cone bits, PDC bits, natural diamond bits, any hole openers, reamers, coring bits, and the like. As drill bit 218 rotates, it may create and extend wellbore 124 that penetrates various subterranean formations 204. A pump 220 may circulate drilling fluid through a feed pipe 222 to kelly 214, downhole through interior of drill string 212, through orifices in drill bit 218, back to surface 108 via annulus 224 surrounding drill string 212, and into a retention pit 226.

With continued reference to FIG. 2, drill string 212 may begin at wellhead 134 and may traverse wellbore 124. Drill bit 218 may be attached to a distal end of drill string 212 and may be driven, for example, either by a downhole motor and/or via rotation of drill string 212 from surface 108. Drill bit 218 may be a part of bottom hole assembly 228 at distal end of drill string 212. Bottom hole assembly 228 may further comprise borehole sonic logging tool 102. Borehole sonic logging tool 102 may be disposed on the outside and/or within bottom hole assembly 228. Borehole sonic logging tool 102 may comprise a plurality of transmitters 128 and/or receivers 130. Borehole sonic logging tool 102 and/or the plurality of transmitters 128 and receivers 130 may operate and/or function as described above. As will be appreciated by those of ordinary skill in the art, bottom hole assembly 228 may be a measurement-while drilling (MWD) and/or logging-while-drilling (LWD) system.

Without limitation, bottom hole assembly 228, transmitter 128, and/or receiver 130 may be connected to and/or controlled by information handling system 114, which may be disposed on surface 108. Without limitation, information handling system 114 may be disposed down hole in bottom hole assembly 228. Processing of information recorded may occur down hole and/or on surface 108. Processing occurring downhole may be transmitted to surface 108 to be recorded, observed, and/or further analyzed. Additionally, information recorded on information handling system 114 that may be disposed down hole may be stored until bottom hole assembly 228 may be brought to surface 108. In examples, information handling system 114 may communicate with bottom hole assembly 228 through a communication line (not illustrated) disposed in (or on) drill string 212. In examples, wireless communication may be used to transmit information back and forth between information handling system 114 and bottom hole assembly 228. Information handling system 114 may transmit information to bottom hole assembly 228 and may receive, as well as process, information recorded by bottom hole assembly 228. In examples, a downhole information handling system (not illustrated) may include, without limitation, a microprocessor or other suitable circuitry, for estimating, receiving and processing signals from bottom hole assembly 228. Downhole information handling system (not illustrated) may further include additional components, such as memory, input/output devices, interfaces, and the like. In examples, while not illustrated, bottom hole assembly 228 may include one or more additional components, such as analog-to-digital converter, filter and amplifier, among others, that may be used to process the measurements of bottom hole assembly 228 before they may be transmitted to surface 108. Alternatively, raw measurements from bottom hole assembly 228 may be transmitted to surface 108.

Any suitable technique may be used for transmitting signals from bottom hole assembly 228 to surface 108, including, but not limited to, wired pipe telemetry, mud-pulse telemetry, acoustic telemetry, and electromagnetic telemetry. While not illustrated, bottom hole assembly 228 may include a telemetry subassembly that may transmit telemetry data to surface 108. Without limitation, an electromagnetic source in the telemetry subassembly may be operable to generate pressure pulses in the drilling fluid that propagate along the fluid stream to surface 108. At surface 108, pressure transducers (not shown) may convert the pressure signal into electrical signals for a digitizer (not illustrated). The digitizer may supply a digital form of the telemetry signals to information handling system 114 via a communication link 230, which may be a wired or wireless link. The telemetry data may be analyzed and processed by information handling system 114.

As illustrated, communication link 230 (which may be wired or wireless, for example) may be provided which may transmit data from bottom hole assembly 228 to an information handling system 114 at surface 108. Information handling system 114 may include a processing unit 116, a video display 120, an input device 118 (e.g., keyboard, mouse, etc.), and/or non-transitory computer-readable media 122 (e.g., optical disks, magnetic disks) that may store code representative of the methods described herein. In addition to, or in place of processing at surface 108, processing may occur downhole.

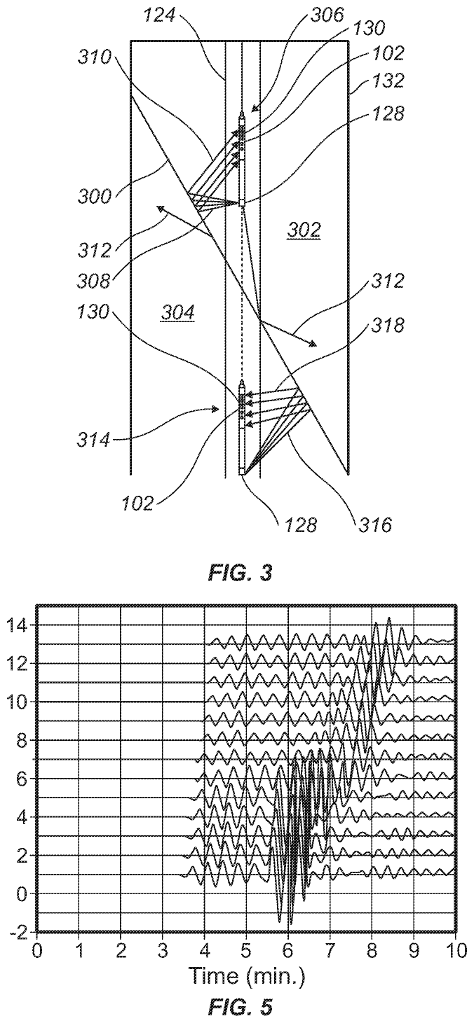

FIG. 3 illustrates an example of borehole sonic logging tool 102 disposed in wellbore 124. Concerning the present disclosure, borehole sonic logging tool 102 may be used to develop an improved reflection borehole sonic image by using image-guided velocity models using an iterative process and/or determine the true dip angle of a formation by using an output of formation relative dip and other data. In examples, borehole sonic logging tool 102 may comprise transmitter 128 and receiver 130. There may be a plurality of transmitters 128 and/or receivers 130. As illustrated, the borehole sonic logging tool 102 may comprise a plurality of receivers 130 that may be spaced along the longitudinal axis of the borehole sonic logging tool 102. As illustrated, one or more of the receivers 130 may be spaced from the transmitters 128. In examples, the plurality of transmitters 128 may be dipole sources and/or monopole sources.

As illustrated in FIG. 3, borehole sonic logging tool 102 may pass by a bed boundary 300. In examples, bed boundary 300 may be dipping at some angle relative to the horizontal plane. Borehole sonic logging tool 102 may be positioned in wellbore 124 within subterranean formation 132. Subterranean formation 132 may include a number of different formation beds, including bed 302 and adjacent bed 304. As illustrated, borehole sonic logging tool 102 may be positioned in wellbore 124 in bed 302. At a first position 306 in wellbore 124, the transmitters 128 may be actuated to fire signals shown as emitted waves 308. As indicated, emitted waves 308 from first position 306 may be emitted into bed 302 and reflected at bed boundary 300 to generate reflected waves in the form of up going reflection waves 310, which may be received at one or more receivers 130. As illustrated, additional emitted waves 312 from first position 306 may reflect off bed boundary 300 and continue into bed 302 without being received at one or more receivers 130. Borehole sonic logging tool 102 may then be moved in wellbore 124 across bed boundary 300 to a second position 314 in wellbore 124 within adjacent bed 304. At second position 314 in wellbore 124, the transmitters 128 may be actuated to fire additional signals shown as emitted waves 316. As indicated, emitted waves 316 from second position 314 may be emitted into bed 302 and reflected at bed boundary 300 to generate reflected waves in the form of down going reflection waves 318, which may be received at one or more receivers 130. As illustrated, additional emitted waves 312 from second position 314 may reflect off bed boundary 300 and continue into adjacent bed 304 without being received at one or more receivers 130. While the previous example of acquiring data first from bed 302 then from adjacent bed 304 was described, one of ordinary skill in the art may first acquire data from adjacent bed 304 and then from bed 302.

In this manner, sound waves, such as compressional (P) and/or shear (S) wave data may be gathered along wellbore 124. Typically, an operator who provides borehole sonic imaging services may use the average recorded velocity, for either P-wave or S-wave data depending on the mode of interest, along wellbore 124 as the background velocity model. In examples, an operator may be defined as an individual, group of individuals, or an organization. It may be desirable for reflection sonic imaging to separately image the crossing of dipping formation bed 304 with wellbore 124 and to combine the resultant image to create a 2-dimensional visualization. Pre-separation, which may use any suitable algorithm, of up going reflection waves 310 and down going reflection waves 318 received at receivers 130 may be utilized.

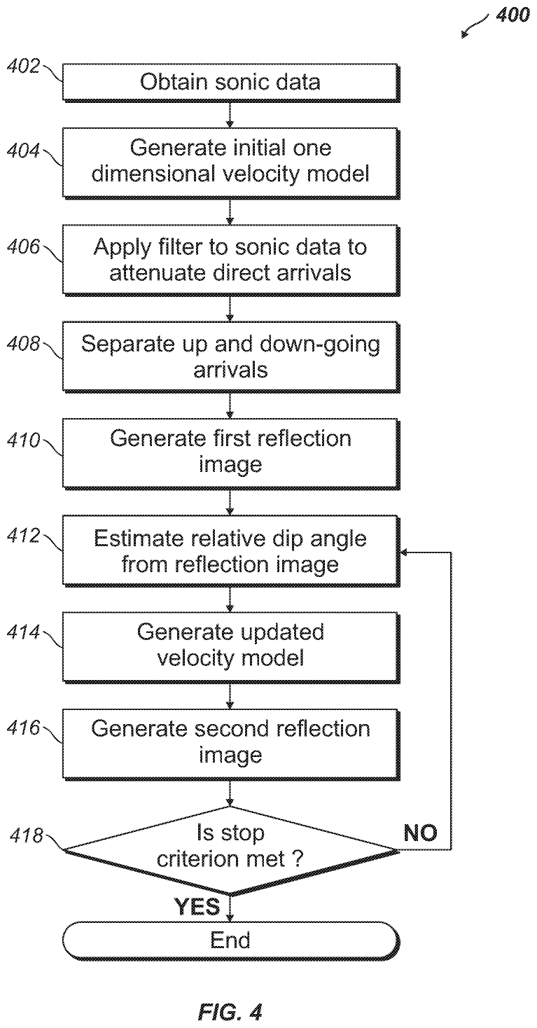

FIG. 4 illustrates a flowchart 400. Flowchart 400 may depict a method to update a velocity model to achieve an accurate and high-quality borehole sonic image of for dipping formation bed 304 (e.g., referring to FIG. 3) that may be near wellbore 124 (e.g., referring to FIG. 1). Flowchart 400 may comprise multiple steps to create the reflection borehole sonic image and/or determine the relative dip angle of bed boundary 300. At step 402, flowchart 400 may include obtaining borehole sonic data. The borehole sonic data may be obtained using any suitable technique. As previously described, the borehole sonic data may be obtained by firing one or more transmitters 128 (e.g., referring to FIG. 3) to generated sound waves (e.g., emitted sounds waves 304 on FIG. 3). One or more receivers 130 may be used to receive sound waves, for example, by measuring one or more properties of at least a portion of the sound waves. By way of example, the receivers 130 may measure velocity, amplitude, amplitude attenuation, and frequency. The sound waves may include both direct waves that traveled along the wellbore 124 as well as waves that traveled through formation 132, including, but not limited to, shear (S) waves, compressional (P) waves, and Stoneley waves. Some of the sound waves emitted from the transmitters 128 may not be received at receivers 130.

The borehole sonic data may include any suitable sonic data for generating a formation image for dip analysis. Suitable data may include full-waveform data and the corresponding velocity logs. The term “full-waveform” data may be defined as data recorded at each receiver of the signal response of the waves impacting the receiver, as a function of time. The data may include P-wave data, S-wave data, or both P-wave data and S-wave data. FIG. 5 illustrates raw data measured with a borehole sonic logging tool 102 (e.g., referring to FIG. 1) that includes thirteen receivers 130. The first detectable arrivals for the data may be the flexural waves of wellbore 124 (e.g., referring to FIG. 1) that are used to measure the shear slowness of the near-borehole formation 132 (e.g., referring to FIG. 1) along the axis of wellbore 124. In addition to this wellbore mode, true formation body shear may be excited by transmitters 128 and will radiate away from wellbore 124. In examples, the flexural waves may be further processed to estimate S-wave slowness. Some monopole components may be present as well that can have application. For example, P-wave data may be used for reflection imaging, however, the focus with this source firing and receiver configuration may be the dipole generated signals that include the borehole flexural wave and shear waves radiated away from the borehole.

After obtaining the borehole sonic data, step 404 may then be implemented. Step 404 may comprise generating an initial 1-dimensional (1-D) velocity model that follows the path of wellbore 124 as a function of depth. The initial 1-D velocity model may be generated using any suitable technique, including using a smoothed velocity log of the measured sounds (as either P-wave or S-wave data), for example, recorded by the borehole sonic logging tool 102 (e.g., referring to FIG. 3). The initial 1-D velocity model may illustrate variance in depth of wellbore 124. Without limitation, any suitable technique may be applied to the borehole sonic data to obtain the smoothed velocity log. For example, a running average or median filter may be applied to a velocity log from the borehole sonic data to obtain the smooth velocity log.

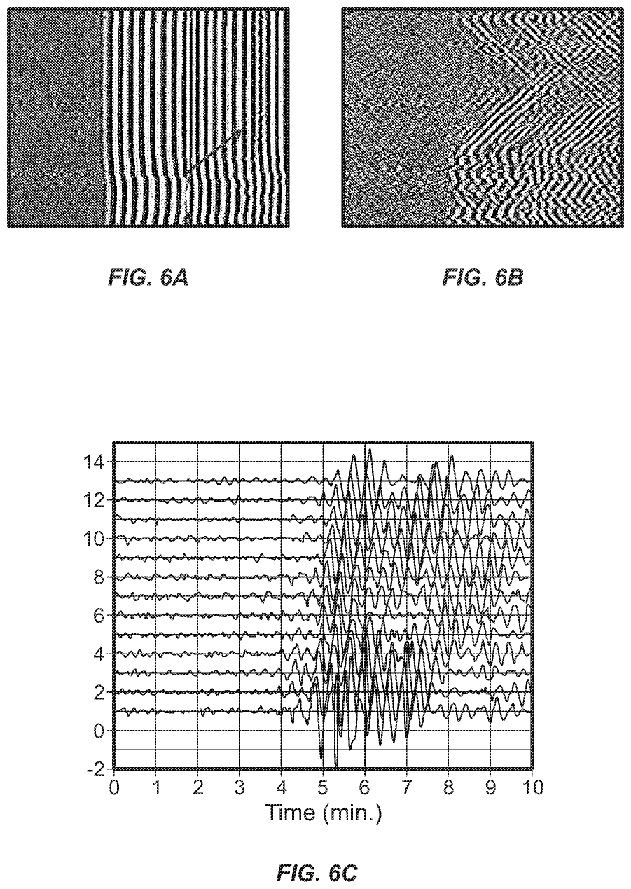

Step 406 may be implemented before and/or after creating the 1-D velocity model. In step 406, a filter may be applied to the borehole sonic data to attenuate direct arrivals. The direct arrivals typically may include the measured sound waves that traveled directly along wellbore 124 from transmitter 128 to receiver 130 (e.g., referring to FIGS. 1-3). Any suitable filter may be applied to the borehole sonic data to attenuate the direct arrivals. Suitable filters may include, but are not limited to a frequency domain filter, an F-K filter, a median filter, and/or combinations thereof. The filter may be applied to borehole sonic data from a single one of receivers 130 or to borehole sonic data from multiple of receivers 130. During operation of a sonic logging tool (e.g., borehole sonic logging tool 102 on FIGS. 1-3), the desired sound waves (e.g., up going reflection waves 310 or down going reflection waves 318 on FIG. 3) may be reflected off of a bed boundary (e.g. bed boundary 300 on FIG. 3). Arrival sound waves that travel along the axis of wellbore 124 may arrive at a near-constant arrival time and may slowly change across bed boundaries. Arrival signals that reflect off of bed boundaries away from wellbore 124 may arrive at oblique times. FIGS. 6A-6B show the recorded data plotted for a single source-receiver offset as a function of depth. FIG. 6A illustrates the raw recorded data. FIG. 6B illustrates data after application of a suitable filter to attenuate the direct arrivals. In this example, a median filter was applied to the data on FIG. 6A to generate FIG. 6B with attenuated direct arrivals. The oblique arrival signals may be depicted in comparison of FIG. 6A with FIG. 6B. As seen, the oblique arrival signals may be clearly seen on FIG. 6B after attenuation of the direct arrival signals. FIG. 6C illustrates the reflected data for a single depth at 12930 ft. In examples, FIG. 6C may depict a similar graph compared to FIG. 5; however, FIG. 6C depicts the reflected data after the application of a suitable filter to attenuate the direct arrival signals.

After the attenuation of the direct arrivals, step 408 may comprise of separating up- and down-going arrivals in the borehole sonic data. As previously described, the up- and down-going arrivals may have been received along the borehole sonic logging tool 102 (e.g., referring to FIG. 3) at different depths. The borehole sonic data may include up going reflection waves 310 (e.g., referring to FIG. 3) and down going reflection waves 318 (e.g., referring to FIG. 3) that were obtained from either side of the bed boundary 300. Any suitable technique of wave separation may be used to separate the up-going arrivals from the down-going arrivals, including, but not limited to, a frequency domain filter, an F-K filter, a median filter, and/or combinations thereof.

After the separation of the up-going arrivals from the down-going arrivals, step 410 may occur. Step 410 may comprise generation of a first reflection image based on the borehole sonic data. The first reflection image may be a two-dimensional (2-D) image of subsurface structures in a subterranean formation (e.g., formation 132 on FIGS. 1-3). In this 2-D image, one of the dimensions may be radial distance away from wellbore (e.g., from borehole wall or borehole axis) and the other dimension may be logging depth along wellbore 124 (e.g., FIG. 1). In some examples, the first reflection image may be generated by applying a filter to the borehole sonic data (step 404), which may be optional. Generation of the first reflection image may include separately imaging measurements from either side of bed boundary 300 (e.g., referring to FIG. 3), for example, by generating an up-going reflection image from the up-going arrivals (e.g., up-going reflection waves on FIG. 3) and a down-going reflection image from down-going arrivals (e.g., down-going reflection waves on FIG. 3), which may then be combined to generate the first reflection image. In addition to the up- and down-going arrivals, the up-going and down-going reflection image may also be generated from the 1-D background velocity model from step 404.

The up-going and down-going reflection image may be generated from the up-and down-going arrivals and the 1-D background velocity model through a pre-stack depth imaging code, such as Reverse-Time Migration (RTM) imaging, to produce the reflection images of formation structures away from wellbore 124 (e.g., referring to FIGS. 1-3). In examples, RTM may be a full-featured image algorithm using 2-way wave propagation. Without limitation, any other suitable pre-stack depth imaging methods may be used. The present disclosure is not limited as to the complexity of the velocity model, so other appropriate models may be applied. In generation of the 1-D velocity mode used to create the first reflection image, the 1-D velocity model may assume that the formation bed boundaries away from the well are flat and oriented orthogonal to the borehole path (e.g., horizontal beds for a vertical well may have a 0 degree dip and so oriented orthogonal to a vertical wellbore). In addition, with the 1D velocity mode assumption, simpler techniques may be used to generate the first reflection image, such as by use of local image grids with constant velocity. However, flat bedding oriented orthogonal to the wellbore may not be of interest for imaging as arrivals will only reflect up and down the borehole and signals reflected off of bedding away from the borehole will not be generated. On average, most formation beds may have a relative dip angle (to the plane orthogonal to wellbore 124) of about thirty degrees or more.

Flowchart 400 may then proceed to step 412, which may comprise of estimating the relative dip angle from the first reflection image. For example, the relative dip angle of bed 302 (e.g., referring to FIG. 3), which crosses the wellbore 124, may be estimated from the first reflection image. As previously described, the relative dip angle is defined as the angle measured between a plane orthogonal to the wellbore axis and the vector normal to the formation bedding plane. In examples, estimation of this relative dip angle may occur manually and/or automatically. Manual estimation may occur, for example, from interpretation of the first reflection image. Without limitation, the relative dip angle may be estimated by information handling system 114 (e.g., referring to FIG. 1), for example, by using a semblance algorithm or any other suitable algorithm that will respond to arrival signals that align in a straight line. Without limitation, the relative dip angle may be any suitable angle between 0 and 90 degrees.

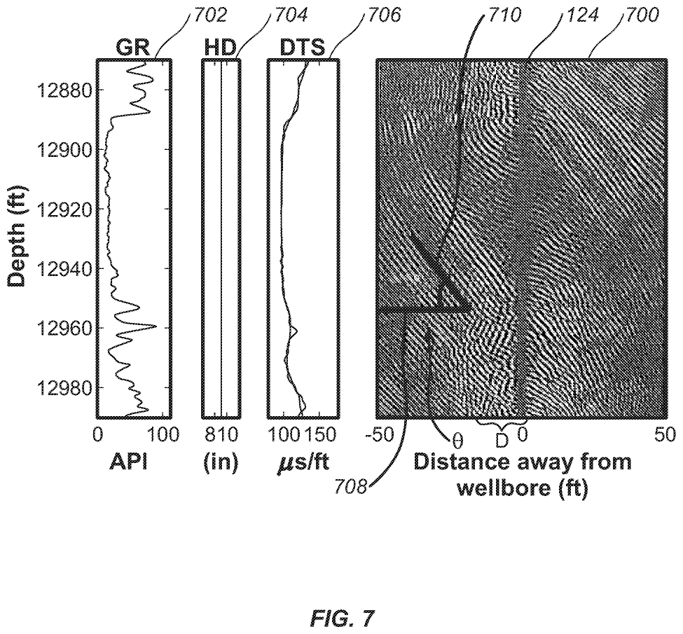

An example of estimating relative dip angle from a reflection image, such as first reflection image is provided on FIG. 7. An example of a 2-D reflection image 700 may be displayed as illustrated in FIG. 7. The 2-D reflection image 700 may be generated from combining reflection images that were separately generated from up- and down-going reflections. As illustrated, 2-D reflection image 700 may include wellbore 124. Additional log curves may also be shown on FIG. 7. Without limitation, the additional log curves may include one or more of a gamma ray log 702, a hole diameter log 704, and/or a slowness log 706. By interpretation of 2-D reflection image 700, the relative dip angle may be estimated manually. As illustrated, the relative dip angle may be shown as angle θ between the plane orthogonal to the wellbore axis (shown as line 708) and the vector normal to the formation bedding plane (shown as line 710). In the present example, the relative dip angle may be 48 degrees. The relative dip angle may be determined, as shown in FIG. 7, at a distance D, away from a central axis of wellbore 124. The distance D may be any suitable distance away from wellbore, for example, at a distance D of 5 feet (1.5 meters), 10 feet (3 meters), 20 feet (6 meters), 50 feet (15 meters), 100 feet (305 meters), or even further from the wellbore.

After the relative dip angle is estimated, step 414 may occur. Step 414 may comprise generating an updated velocity model. The updated velocity model may be a 2-D velocity model. In the 2-D velocity model, one of the dimensions may be radial distance away from wellbore (e.g., from borehole wall or borehole axis) and the other dimension may be logging depth along wellbore 124 (e.g., FIG. 1). The updated velocity model may show the velocity structure away from wellbore 124 as perturbed by the relative dip angle from step 412. The relative dip angle may be used in determination of the updated velocity model. Without limitation, a possible sequence that may be implemented to create the 2-D velocity model using the borehole measured velocity log and estimated relative dip angle as a function of depth is as follows.

The velocity log may be prepared in a similar fashion as was done for the 1-D velocity model (e.g. smoothing the log response). Then the 2-D velocity model grids may be created. A first model may be created for imaging up-dip structures, and a second model may be created for imaging down-dip structures. To create the first and second models, a matrix representing a series of cells may be created that extends along the wellbore and laterally away from the wellbore to the extent of the desired distance to be imaged. For example, to see events about 100 feet (30.5 meters) from the well and from test data gathered in a 1000 feet (305 meters) section in the well, the grid may be created over the well depth interval and laterally to 100 feet (30.5 meters) from the well. Spacing between grid points may need to be close to achieve an image that is useful. In examples, too fine of a spacing may cause excessive computing time for the imaging process. The spacing parameter may be subjective. For example, the spacing parameter may be decided by trial and error. Without limitation, a spacing of about 0.25 feet (7.6 centimeters) may produce a good result for borehole sonic frequency imaging.

Next, the prepared velocity log may be placed on the same depth locations as the 2-D velocity model matrix. In examples, as the 2-D velocity model matrix may be at a finer depth sampling spacing than the prepared velocity log (e.g., 0.5 feet (16.5 centimeters) as opposed to 0.25 ft (7.6 centimeters), the prepared velocity log may be interpolated to get the velocity at the corresponding 2-D velocity matrix depth. Then, the velocity model grids may be populated. At the borehole wall, the velocity at each depth may be the prepared velocity model positioned at the 2-D velocity model depth locations. Without limitation, trigonometric methods may be used with the relative dip angle to populate the velocity model away from the wellbore. For example, the cell at a lateral distance “dx” from the borehole, for each borehole depth position “y” and lateral distance “x”, may be extracted by Equation (1):

dy=tan(α)*x (1)

where “dy” is the depth above the current borehole depth “y”. Once “dy” has been determined, the velocity for that matrix point may be calculated using Equations (2) and (3):

V_matrix(x,y)=V(y+dy) (2)

V_matrix(x,y)=V(y−dy) (3)

wherein “V” is the 1-D prepared velocity model and “V_matrix” is the 2-D velocity model matrix. Equation (2) may be used for a down-dip matrix, and Equation (3) may be used for an up-dip matrix.

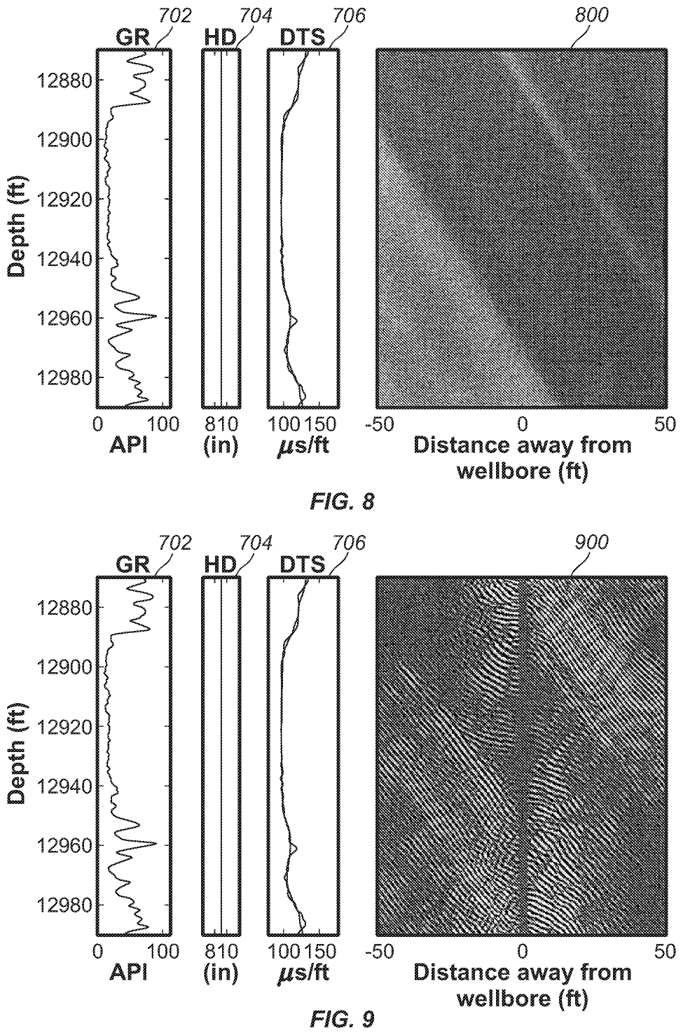

An example of an updated 2-D velocity model 800 that may be generated using the relative dip angle is illustrated in FIG. 8. Velocity model 800 may show the combined up-dip and down-dip velocity models. Additional log curves may also be shown on FIG. 8. Without limitation, the additional log curves may include one or more of a gamma ray log 702, a hole diameter log 704, and/or a slowness log 706.

Alternatively, another example may be enhancement of processing to allow the imaging of a formation 132 that may be more complex located away from wellbore 124 by taking into more complex structural changes in formation 132 when generating updated velocity model. The methods previously described may be initially implemented using an assumption that the relative dip angle of formation 132 is constant (linear) for the imaged region away from wellbore 124. That may not always be the case as geological structures can change within relatively short distances. In this example, the iterative solution to update the 2-D velocity model along the relative dip angle as a function of depth in flowchart 400 may take into account complex structural changes in formation 132. Without limitation, the complex structural changes may include, but is not limited to, discrete relative dip angle changes away from wellbore 124, such as the presence of a fault, fold structure such as anticlines and synclines, and/or the like.

After the creation of the 2-D velocity model, step 416 may occur. Step 416 may comprise generating an updated reflection image, wherein the updated reflection image may be 2-D. In the updated reflection image, one of the dimensions may be radial distance away from wellbore (e.g., from borehole wall or borehole axis) and the other dimension may be logging depth along wellbore 124 (e.g., FIG. 1). Generation of the updated reflection image may comprise re-imaging the up-going arrivals and the down-arrivals based on the updated velocity model to generate separate images, which may then be combined to generate the updated reflection image. Any suitable technique may be used for generation of the images, including, but not limited to, RTM imaging or other suitable models. An example of an updated reflection image 900 may be displayed as illustrated in FIG. 9. Additional log curves may also be shown on FIG. 9. Without limitation, the additional log curves may include one or more of a gamma ray log 702, a hole diameter log 704, and/or a slowness log 706.

A subsequent step may be a decision step 418 to determine whether a stop criterion has been met. In decision step 418, a determination may be made whether change between the updated reflection image and the first reflection image is acceptable. In examples, this may occur manually and/or automatically based on a suitable tolerance based on the actual changes in the 2D image matrix from one iteration to the next. The suitable tolerance may be between 0% and 10%. Without limitation, a suitable tolerance may be from about 0% to about 2.5%, from about 2.5% to about 5%, from about 5% to about 7.5%, or from about 7.5% to about 10%. In examples, bedding may not be expected to change a given distance away from the borehole, but an up-dip structure near 12910 feet to 12890 feet (3935 meters to 3929 meters) observed on FIG. 9. By using the structure guided velocity model 800 (e.g., referring to FIG. 8), it may be observed that updated reflection image 900 (e.g., referring to FIG. 9) is more consistent away from wellbore 124 (e.g., referring to FIG. 1). If the stop criterion is not met such that the change between the updated reflection image and the first reflection image is acceptable, flowchart 400 may proceed to step 412 to the estimation of an updated relative dip angle from updated reflection image 900, then step 414 to generate an updated velocity model, and then step 416 to generate an additional reflection image. In this manner, steps 412 to 416 may be repeated indefinitely until the stop criterion in decision step 418 is met and/or may be repeated a finite number of times. If the stop criterion is met such that the change between the reflection images is acceptable, flowchart 400 may end thereafter. The resulting product from flowchart 400 may be the relative dip angle from step 412 and a final reflection image from step 416 that may be more accurate.

In examples, a true dip angle of a formation bed (e.g., bed boundary 300 on FIG. 3) may be desired. The true dip angle may be determined by using wellbore directional survey information along with processed results of relative dip angle as a function of depth. First, the relative dip angle of the formation bed, as a function of depth, may be obtained. The relative dip angle may be obtained as described above with respect to flowchart 400 and/or any other suitable technique. Next, the dip and direction of wellbore 124 (e.g., referring to FIG. 1) may be obtained with a borehole directional survey measured during the drilling of wellbore 124 and/or measured during the wireline logging of the borehole sonic data and with a suitable tool module positioned in the same string as borehole sonic logging tool 102 (e.g., referring to FIGS. 1-3).

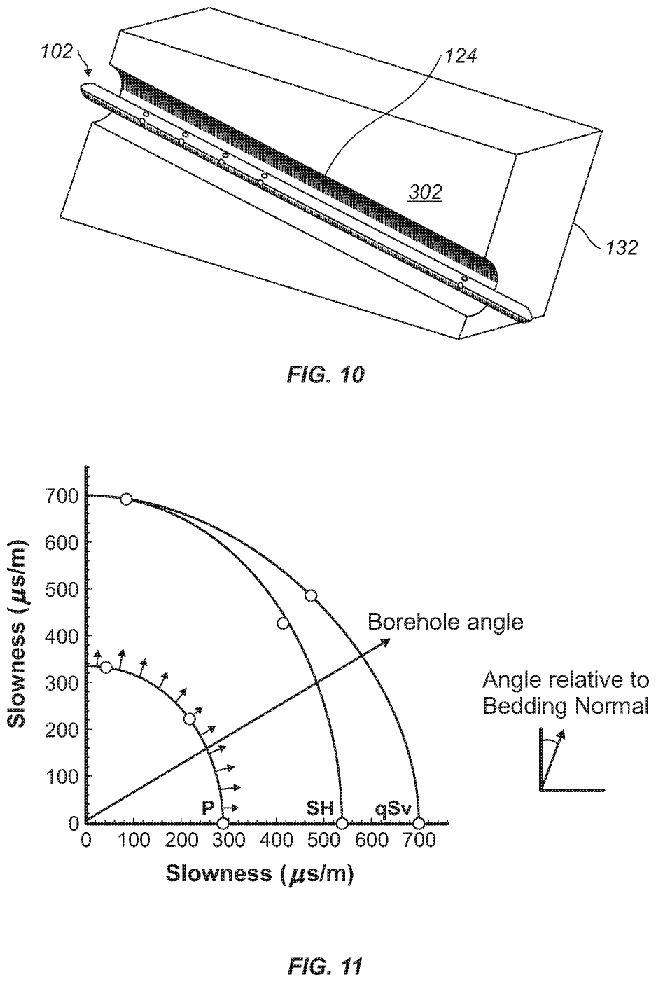

Next, the strike of the formation bed may be determined. The strike may refer to a line that represents the intersection of the formation bed with a horizontal plane. The strike may be determined using any suitable technique, including, but not limited to, by use of Horizontal Transverse Isotropy (HTI) analysis of the 4-component dipole data. In examples, for the case of borehole sonic logging tool 102 in a wellbore penetrating a dipping bed, as shown on FIG. 3, the polarization of the Fast SH shear mode may line up with the direction of the strike of formation 132. To illustrate this effect, FIG. 10 is shown depicting borehole sonic logging tool 102 in wellbore 124 penetrating formation 132, which may comprise formation bed, such as bed 302, which is dipping as shown on FIG. 3. In this situation, the horizontally polarized SH mode may propagate in-plane of bed 302 and may determine the strike of bed 302 penetrated by wellbore 124. The direction of fast shear may have a +/−180 degree ambiguity. To resolve this ambiguity, known overall structure details may be considered. In addition, the dip direction, as seen by the wellbore wall imager devices, may be used to directly resolve the +/−180 degree ambiguity from the HTI fast shear direction.

Without limitation, an example structural detail may comprise that formation 132 is drilled down-dip so that the direction close to wellbore 124 direction is the expected direction. Additional structural details may include a wellbore 124, that may be vertical, intersecting a formation 132 that is dipping, a deviated well intersecting a formation 132 that is flat, a deviated well intersecting a formation 132 that is dipping, and/or the like. In alternate examples, the ambiguity may be resolved by integrating with a dipmeter or a wellbore wall image analysis.

FIG. 11 illustrates a graph of the wave modes as a function of slowness. As illustrated, the wave modes may propagate at any suitable angle in the earth as a result of the elastic properties of formation 132 (e.g., referring to FIG. 1). In examples, the phase slowness and polarization for compressional (P), horizontally polarized shear (SH), and quazi-vertical shear (qSv) modes may be depicted. Measurements in wellbore 124 (e.g., referring to FIG. 1) may produce slowness logs at the relative dip angle through a slowness surface (a point on the surface at the relative dip, or angle relative to the normal plane of formation 132). In examples, the “in the plane” SH mode may be the fastest shear mode while “against the grain” qSV mode may be the slowest. SH mode polarization (depicted as dots indicating out of page polarization) may point to the strike direction, which is orthogonal to the direction of dip.

Once the relative dip angle, bedding strike direction, and wellbore deviation and direction are acquired, the true dip angle and direction of formation beds may be calculated. In examples, calculations may be done using standard methods with a suitable logging tool. With the dip angle, an improved reflection image may be obtained. As will be appreciated, the reflection image is typically used for a number of functions, including, but not limited to, providing information for making drilling, completion, and production decisions.

This method and system may include any of the various features of the compositions, methods, and system disclosed herein, including one or more of the following statements.

Statement 1. A method for borehole sonic reflection imaging, comprising: disposing a borehole sonic logging tool in a wellbore, wherein the borehole sonic logging tool comprises one or more transmitters and one or more receivers; emitting sound waves from the one or more transmitters; receiving sound waves at the one or more receivers to obtain borehole sonic data; separating up-going arrivals in the borehole sonic data from down-going arrivals in the borehole sonic data; generating a first reflection image based at least on the borehole sonic data; estimating a relative dip angle of a formation bed from the first reflection image; generating an updated velocity model based at least on the relative dip angle; and generating an updated reflection image based at least on the updated velocity model.

Statement 2. The method of statement 1, wherein the generating a first reflection image comprises separately imaging the up-going arrivals and the down-going arrivals to generate images from measurements on either side of a bed boundary and then combining the images to produce the first reflection image.

Statement 3. The method of statement 2, wherein the separately imaging the up-going arrivals and the down-going arrivals occurs through a pre-stack depth imaging code.

Statement 4. The method of statement 3, wherein the pre-stack depth imaging code is Reverse-Time Migration imaging.

Statement 5. The method of any of the previous statements, wherein the estimating the relative dip angle of the formation bed occurs manually from interpretation of the first reflection image or automatically through an information handling system.

Statement 6. The method of any of the previous statements, wherein the estimating the relative dip angle is performed on an information handling system applying a semblance algorithm.

Statement 7. The method of any of the previous statements, further comprising generating an initial one-dimensional velocity model from at least a smoothed velocity log, wherein the smooth velocity log is obtained by application of a filter to a velocity log in the borehole sonic data.

Statement 8. The method of any of the previous statements, further comprising attenuating direct arrival signals in the borehole sonic data.

Statement 9. The method of statement 8, wherein the direct arrival signals are attenuated with at least one filter selected from the group consisting of a frequency domain filter, an F-K filter, a median filter, and combinations thereof.

Statement 10. The method of any of the previous statements, wherein the updated velocity model comprises a two-dimensional velocity model that was generated by translating an initial one-dimensional velocity model along the relative dip angle as a function of depth.

Statement 11. The method of any of the previous statements, wherein the step of generating the updated reflection image based at least on the updated velocity model comprises separately imaging the up-going arrivals and the down-going arrivals using the updated velocity model to generate images from measurements on either side of a bed boundary and then combining the images to produce the updated reflection image.

Statement 12. The method of any of the previous statements, further comprising comparing the first reflection image to the updated reflection image to determine whether the updated velocity model should be further updated.

Statement 13. The method of any of the previous statements, further comprising determining a true dip angle of the formation bed.

Statement 14. The method of statement 13, wherein the step of determining the true dip angle comprises determining dip and direction of the wellbore, determining strike of the formation bed, and then determining the true dip angle from at least the dip and the direction of the wellbore, the strike, and the relative dip angle.

Statement 15. The method of statement 14, wherein the strike is determined by using Horizontal Transverse Isotropy analysis.

Statement 16. An apparatus for borehole sonic imaging, comprising: a borehole sonic logging tool comprising one or more transmitters configured to emit sound waves and one or more receivers configured to receive sound waves to obtain borehole sonic data; and an information handling system operate configured to obtain the borehole sonic data from the receivers, separate up-going arrivals in the borehole sonic data from down-going arrivals in the borehole sonic data; generate a first reflection image based at least on the borehole sonic data; estimate a relative dip angle of a formation bed from the first reflection image; generate an updated velocity model based at least on the relative dip angle; and generate an updated reflection image based at least on the updated velocity model.

Statement 17. The apparatus of statement 16, wherein the one or more receivers comprises a plurality of receivers spaced along a longitudinal axis of the borehole sonic logging tool.

Statement 18. The apparatus of statement 17, wherein the one or more transmitters comprises one or more piezoelectric transmitters, and wherein the plurality of receivers comprises a plurality of piezoelectric receivers.

Statement 19. The apparatus of any of statements 16 to 18, wherein the information handling system is further configurable to separately image the up-going arrivals and the down-going arrivals to generate images from measurements on either side of a bed boundary and then combine the images to generate the first reflection image.

Statement 20. The apparatus of statement 17, wherein the information handling system is further configurable to generate an initial one-dimensional velocity model from at least a smoothed velocity log, wherein the smooth velocity log is obtained by application of a filter to a velocity log in the borehole sonic data, and also further configured to attenuate direct arrival signals in the borehole sonic data.

The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only, and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method for borehole sonic reflection imaging, comprising:
disposing a borehole sonic logging tool in a wellbore, wherein the borehole sonic logging tool comprises one or more transmitters and one or more receivers;
emitting sound waves from the one or more transmitters;
receiving sound waves at the one or more receivers to obtain borehole sonic data;
separating up-going arrivals in the borehole sonic data from down-going arrivals in the borehole sonic data;
generating a first reflection image based at least on the borehole sonic data;
estimating a relative dip angle of a formation bed from the first reflection image;
generating an updated velocity model based at least on the relative dip angle; and
generating an updated reflection image based at least on the updated velocity model.

2. The method of claim 1, wherein the generating a first reflection image comprises separately imaging the up-going arrivals and the down-going arrivals to generate images from measurements on either side of a bed boundary and then combining the images to produce the first reflection image.

3. The method of claim 2, wherein the separately imaging the up-going arrivals and the down-going arrivals occurs through a pre-stack depth imaging code.

4. The method of claim 3, wherein the pre-stack depth imaging code is Reverse-Time Migration imaging.

5. The method of claim 1, wherein the estimating the relative dip angle of the formation bed occurs manually from interpretation of the first reflection image or automatically through an information handling system.

6. The method of claim 1, wherein the estimating the relative dip angle is performed on an information handling system applying a semblance algorithm.

7. The method of claim 1, further comprising generating an initial one-dimensional velocity model from at least a smoothed velocity log, wherein the smooth velocity log is obtained by application of a filter to a velocity log in the borehole sonic data.

8. The method of claim 1, further comprising attenuating direct arrival signals in the borehole sonic data.

9. The method of claim 8, wherein the direct arrival signals are attenuated with at least one filter selected from the group consisting of a frequency domain filter, an F-K filter, a median filter, and combinations thereof.

10. The method of claim 1, wherein the updated velocity model comprises a two-dimensional velocity model that was generated by translating an initial one-dimensional velocity model along the relative dip angle as a function of depth.

11. The method of claim 1, wherein the step of generating the updated reflection image based at least on the updated velocity model comprises separately imaging the up-going arrivals and the down-going arrivals using the updated velocity model to generate images from measurements on either side of a bed boundary and then combining the images to produce the updated reflection image.

12. The method of claim 1, further comprising comparing the first reflection image to the updated reflection image to determine whether the updated velocity model should be further updated.

13. The method of claim 1, further comprising determining a true dip angle of the formation bed.

14. The method of claim 13, wherein the step of determining the true dip angle comprises determining dip and direction of the wellbore, determining strike of the formation bed, and then determining the true dip angle from at least the dip and the direction of the wellbore, the strike, and the relative dip angle.

15. The method of claim 14, wherein the strike is determined by using Horizontal Transverse Isotropy analysis.

16. An apparatus for borehole sonic imaging, comprising:
a borehole sonic logging tool comprising one or more transmitters configured to emit sound waves and one or more receivers configured to receive sound waves to obtain borehole sonic data; and
an information handling system operate configured to obtain the borehole sonic data from the receivers, separate up-going arrivals in the borehole sonic data from down-going arrivals in the borehole sonic data; generate a first reflection image based at least on the borehole sonic data; estimate a relative dip angle of a formation bed from the first reflection image; generate an updated velocity model based at least on the relative dip angle; and generate an updated reflection image based at least on the updated velocity model.

17. The apparatus of claim 16, wherein the one or more receivers comprises a plurality of receivers spaced along a longitudinal axis of the borehole sonic logging tool.

18. The apparatus of claim 17, wherein the one or more transmitters comprises one or more piezoelectric transmitters, and wherein the plurality of receivers comprises a plurality of piezoelectric receivers.

19. The apparatus of claim 16, wherein the information handling system is further configurable to separately image the up-going arrivals and the down-going arrivals to generate images from measurements on either side of a bed boundary and then combine the images to generate the first reflection image.

20. The apparatus of claim 17, wherein the information handling system is further configurable to generate an initial one-dimensional velocity model from at least a smoothed velocity log, wherein the smooth velocity log is obtained by application of a filter to a velocity log in the borehole sonic data, and also further configured to attenuate direct arrival signals in the borehole sonic data.
